(19) United States
(12) Patent Application Publication
(10) Pub. No.: US 2016/0307655 A1
(43) Pub. Date: Oct. 20, 2016

(54) NUCLEAR INSTRUMENTATION AND CONTROL SYSTEM

(71) Applicant: ALSTOM Technology Ltd, Baden (CH)

(72) Inventors: Walid HADDAD, Cordimanche (FR); Malik BOUDOUDA, Clichy (FR); Laetitia JACQUOT, Vernouillet (FR)

(21) Appl. No.: 15/097,012

(22) Filed: Apr. 12, 2016

(30) Foreign Application Priority Data
Apr. 14, 2015 (EP) 15290104.7

(51) Int. Cl. G21D 3/00; G21D 3/04

(52) U.S. Cl. CPC G21D 3/001; G21D 3/008; G21D 3/04; G21Y 2002/207; G21Y 2004/30

(57) ABSTRACT

An Instrumentation and Control (I&C) system for Emergency Diesel Generator (EDG) of the nuclear power plants is provided. The instrumentation and control system is adapted to be divided into two parts: first and second control parts. The first control part includes Safety I&C functions adapted to be controlled by wired logics based on electromechanical relays. Further, the second control part includes Non-safety I&C functions adapted to be controlled by Programmable Logic Controllers (PLCs)/Human Machine Interface (HMI).

### CROSS-REFERENCE TO RELATED APPLICATION

This application claims priority to European Patent Application No. 15290104.7 filed Apr. 14, 2015, the contents of which are hereby incorporated in its entirety.

### TECHNICAL BACKGROUND

The present invention generally relates to nuclear power plants, and more particularly to a nuclear Instrumentation and Control (I&C) system incorporated in the Emergency Diesel Generator (EDG) of the Nuclear Power Plants.

### BACKGROUND

Emergency Diesel Generators (EDGs) are essential part of the nuclear power plants, whose function is to provide emergency electrical power to critical equipment of the nuclear power plants in case of onsite, offsite events and/or incase when the power source becomes unavailable or degraded.

Generally, EDGs are located in a dedicated area of the nuclear power plant, and includes, along with various other components, an Instrumentation and Control (I&C) system incorporated therein. The I&C systems, such as, speed regulation, synchronous, relaying, Programmable Logical Controller (PLC)/Human machine Interface (HMI), polarity distributions, are important electrical auxiliaries of the EDGs in regard to the efficient operation of the EDGs.

Most of the present I&C systems in the nuclear power plants are based on analog technologies including analog electronic modules, electromagnetic relays etc. These analog technologies are quite a mature and compliant with severe requirements of safety applications in nuclear power plants. However, as such analog technologies based I&C systems become older, they may experience a higher failure rate with associated increased maintenance costs. The primary concern with the extended use of analog systems is effects of aging such as mechanical failures, environmental degradation, and obsolescence.

The technical solutions currently available on the market mainly count on digital technologies such as microprocessors, hardware, and software, PLC. Such digital technologies are essentially free of the drift that afflicts analog electronics, so the scale can be maintained better. However, these digital technologies are relatively new for I&C systems and are raising many technical and procedural issues, such as, the quantification of software reliability fault tolerance, self-testing, signal verification and validation, process system diagnostics etc.

Accordingly, there exists a need for entirely new approaches to achieve the required reliability, and, have a robust and flexible I&C system in terms of maintenance, reliability compactness in economical and effective manner.

### SUMMARY

The present disclosure discloses a nuclear Instrumentation and Control (I&C) system for an Emergency Diesel Generator (EDG) in the nuclear power plants that will be presented in the following simplified summary to provide a basic understanding of one or more aspects of the disclosure that are intended to overcome the discussed drawbacks, but to include all advantages thereof, along with providing some additional advantages. This summary is not an extensive overview of the disclosure. It is intended to neither identify key or critical elements of the disclosure, nor to delineate the scope of the present disclosure. Rather, the sole purpose of this summary is to present some concepts of the disclosure, its aspects and advantages in a simplified form as a prelude to the more detailed description that is presented hereinafter.

A general object of the present disclosure is to describe a nuclear I&C system that may be robust and flexible in terms of maintenance and reliability compactness. Further object of the present disclosure is to describe a nuclear I&C system that may incorporate analog technologies, such as electromechanical relays, as well as digital technologies, such as Programmable Logic Controllers (PLCs) based on the classification of Safety and Non-safety functions of the nuclear I&C system.

In one aspect of the present disclosure, an Instrumentation and Control (I&C) system for Emergency Diesel Generator (EDG) of the nuclear power plants is provided. The I&C system is adapted to be divided into parts, i.e., a first control part and a second control part. The first control part includes Safety I&C functions adapted to be controlled by wired logics based on electromechanical relays. Further, the second control part includes Non-safety I&C functions adapted to be controlled by Programmable Logic Controllers (PLCs)/Human Machine Interface (HMI).

In accordance with an embodiment, the Safety I&C functions may be related to availability and efficiency of EDG, which may at least be one of an Emergency Starting/Stopping EDG, a Speed Control Unit, Excitations and Regulation Unit, Fuel Oil System, Lube Oil System, and Preheating and Cooling Water System. Further the Non-safety I&C functions may be related to indications, measuring and monitoring systems of EDG, which may at least be one of Alarm Systems, Physical Measurement Systems, Non-Safety Electrical Protections, and Synchronization.

In accordance with an embodiment, the Safety and Non-safety functions may be configured to include respective interface functions thereof, wherein the interface functions include respective input and outputs signals of the Safety and Non-safety functions.

In accordance with an embodiment, I&C system may further include a protection means to protect data exchanges between the first control part incorporating Safety I&C functions and second control part incorporating Non-safety I&C functions. In an embodiment, the protection means may be based on physical separation between classified circuits of the Safety and Non-safety I&C functions in the first and second control parts. In further embodiment, the protection means may be based on electrical insulation between the Safety and Non-safety I&C functions in the first and second control parts.

These together with the other aspects of the present disclosure, along with the various features of novelty that characterize the present disclosure, are pointed out with particularity in the present disclosure. For a better understanding of the present disclosure, its operating advantages, and its uses, reference should be made to the accompanying drawings and descriptive matter in which there are illustrated exemplary embodiments of the present disclosure.

### BRIEF DESCRIPTION OF THE DRAWINGS

The advantages and features of the present disclosure will better understood with reference to the following detailed description and claims taken in conjunction with the accompanying drawing, wherein like elements are identified with like symbols, and in which:

FIG. 1 illustrates a block diagram of Instrumentation and Control (I&C) system for Emergency Diesel Generator (EDG) of the nuclear power plants, in accordance with an exemplary embodiment of the present disclosure.

Like reference numerals refer to like parts throughout the description of several views of the drawings.

### DETAILED DESCRIPTION

For a thorough understanding of the present disclosure, reference is to be made to the following detailed description, including the appended claims, in connection with the above-described drawings. In the following description, for purposes of explanation, numerous specific details are set forth in order to provide a thorough understanding of the present disclosure. It will be apparent, however, to one skilled in the art that the present disclosure can be practiced without these specific details. In other instances, structures and devices are shown in block diagrams form only, in order to avoid obscuring the disclosure. Reference in this specification to “one embodiment,” “an embodiment,” “another embodiment,” “various embodiments,” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but may not be of other embodiment's requirement.

Although the following description contains many specifics for the purposes of illustration, anyone skilled in the art will appreciate that many variations and/or alterations to these details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure. Further, the relative terms used herein do not denote any order, elevation or importance, but rather are used to distinguish one element from another. Further, the terms “a,” “an,” and “plurality” herein do not denote a limitation of quantity, but rather denote the presence of at least one of the referenced item.

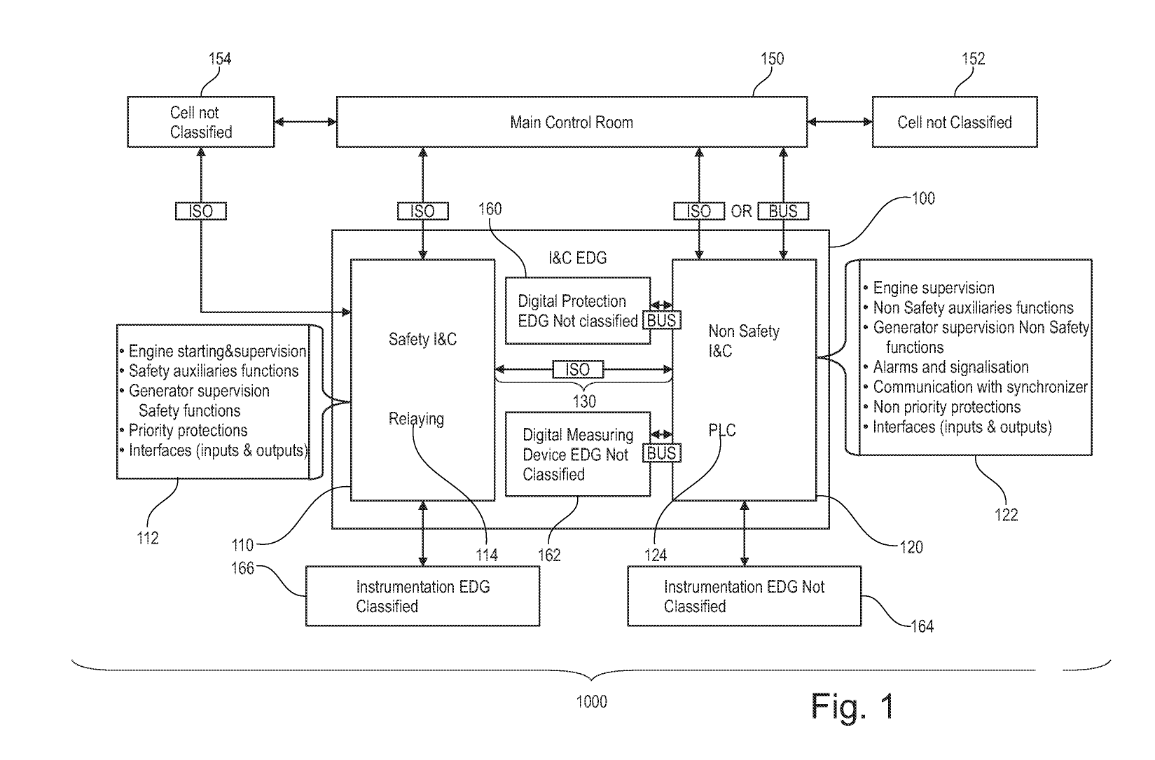

Referring to FIG. 1, an example block diagram of Instrumentation and Control (I&C) system 100 (hereinafter referred to as ‘I&C system 100’) for an Emergency Diesel Generator (EDG) 1000 of the nuclear power plants is illustrated in accordance with an exemplary embodiment of the present disclosure. In as much as the construction and arrangement of the I&C system 100, various associated elements may be well-known to those skilled in the art, it is not deemed necessary for purposes of acquiring an understanding of the present disclosure that there be recited herein all of the constructional details and explanation thereof. Rather, it is deemed sufficient to simply note that as shown in FIG. 1, in the I&C system 100, only those components are shown that are relevant for the description of various embodiments of the present disclosure.

As shown in FIG. 1, the I&C system 100 is adapted to be divided into parts, i.e., a first control part 110 and a second control part 120. The first control part 110 includes Safety I&C functions, as depicted in block 112, adapted to be controlled by wired logics based on electromechanical relays 114. Further, the second control part 120 includes Non-safety I&C functions, as depicted in block 122, adapted to be controlled by Programmable Logic Controllers (PLCs)/Human Machine Interface (HMI) 124.

In accordance with an embodiment, as depicted in the block 112, the Safety I&C functions may be related to availability and efficiency of EDG, which may at least be one of an Engine Emergency Starting/Stopping system and supervision, a Speed Control Unit, an Excitations and Regulation Unit, Fuel Oil System, Lube Oil System, and Preheating and Cooling Water System, and Generator supervision safety and safety auxiliary functions etc.

Further the Non-safety I&C functions, as depicted in the block 122, may related to indications, measuring and monitoring systems of EDG, which may at least be one of Alarm and signalization Systems, Physical Measurement Systems, Non-Safety Electrical Protections, and Synchronization, etc.

In accordance with an embodiment, the Safety and Non-safety functions may be configured to include respective interface functions thereof, wherein the interface functions include respective input and outputs signals of each Safety and Non-safety functions.

In accordance with an embodiment, I&C system may further include a protection means, 130 to protect data exchanges between the first control part incorporating Safety I&C functions and second control part incorporating Non-safety I&C functions. In an embodiment, the protection means may be based on physical separation, such as specific gap 130, between classified circuits of the Safety and Non-safety I&C functions of the in the first and second control parts 110, 120. In further embodiment, the protection means may be based on electrical insulation (not shown) between the Safety and Non-safety I&C functions in the first and second control parts 110, 120.

The I&C system 100 is adapted to be communicably configured to various other units. For example, the first and second control parts 110, 120 relating to the Safety and Non-safety I&C functions are adapted and configured to communicate with a main control room 150, which is also in communication with various other non-classified units 152, 154. The second control part 120 may for example communicates with a non-classified Digital Protection EDG 160, a non-classified Digital Measuring Device EDG 162, and non-classified Instrumentation EDG 164. Similarly, the first control part 110 may for example communicates with non-classified Instrumentation EDG 166 and other non-classified unit 154. FIG. 1 is only an example block illustration of the I&C system 100, and the scope of the present disclosure should not considered limiting in any sense to FIG. 1, which may include various modifications, arrangement or rearrangement as per the industry need and requirement.

The system 100 of the present disclosure is advantageous in various scopes such as described above. Further, the system is advantageous in incorporating analog technologies, such as electromechanical relays, as well as digital technologies, such as Programmable Logic Controllers (PLCs) based on the classification of Safety and Non-safety functions of the nuclear I&C system. The system economically and effectively provides robustness and flexibility in terms of maintenance and reliability compactness.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omission and substitutions of equivalents are contemplated as circumstance may suggest or render expedient, but such are intended to cover the application or implementation without departing from the spirit or scope of the claims of the present disclosure.

What is claimed is:

1. An Instrumentation and Control (I&C) system for Emergency Diesel Generator (EDG) of the nuclear power plants, the instrumentation and control system, comprising:
a first control part having Safety I&C functions adapted to be controlled by wired logics based on electromechanical relays; and
a second control part having Non-safety I&C functions adapted to be controlled by Programmable Logic Controllers (PLCs)/Human Machine Interface (HMI).

2. The nuclear instrumentation and control system as claimed in claim 1, wherein the Safety I&C functions is related to availability and efficiency of EDG, which is at least one of an Engine Emergency Starting/Stopping system and supervision, a Speed Control Unit, Excitations and Regulation Unit, Fuel Oil System, Lube Oil System, and Preheating and Cooling Water System, Generator supervision safety and safety auxiliary functions.

3. The nuclear instrumentation and control system as claimed in claim 1, wherein Non-safety I&C functions is related to indications, measuring and monitoring systems of EDG, which is at least one of Alarm and signalization Systems, Physical Measurement Systems, Non-Safety Electrical Protections, and Synchronization.

4. The nuclear instrumentation and control system as claimed in claim 1, wherein the Safety and Non-safety functions are configured to include respective interface functions thereof, wherein the interface functions include respective input and outputs signals of the Safety and Non-safety functions.

5. The nuclear instrumentation and control system as claimed in claim 1, further comprising a protection means to protect data exchanges between the first control part incorporating Safety I&C functions and second control part incorporating Non-safety I&C functions.

6. The nuclear instrumentation and control system as claimed in claim 5, wherein the protection means is based on physical separation between classified circuits of the Safety and Non-safety I&C functions in the first and second control parts.

7. The nuclear instrumentation and control system as claimed in claim 5, wherein the protection means is based on electrical insulation between the Safety and Non-safety I&C functions in the first and second control parts, wherein the electrical insulation is realized by Optocouplers, interface relays, converters, transformers, fuses and a plurality of power supplies.
